(19) United States
(12) Patent Application Publication
(10) Pub. No.: US 2007/0050089 A1
(43) Pub. Date: Mar. 1, 2007

(54) Method for detecting the position and orientation of holes using robotic vision system

(76) Inventors: Yunquan Sun, Windsor, CT (US); Qing Tang, Windsor, CT (US)

Correspondence Address: Kenneth Onyema;Cambridge Lawyers Group, LLC, Level 01, 929 Massachusetts Avenue, Cambridge, MA, 02139, US

(21) Appl. No.: 11/217,735

(22) Filed: Sep. 1, 2005

(51) Int. Cl. G05B 19/04

(52) U.S. Cl. 700/254

(57) ABSTRACT

This invention is about the method for detecting the position, and orientation of holes using a robotic vision system. In certain industrial applications, there are parts with many tiny or large holes or tunnels of various shapes, and the orientation and position of each of the holes need to be inspected automatically using non-contact measuring systems such as a vision system. The relative motion of the hole being measured and the measuring system can be realized by an industrial robot or other multiaxis CNC motion systems. The method in this invention includes the approaches and algorithms to detect the hole position, size, and orientation by using a vision system mounted on the robot arms. The hole orientation is determined based on the alignment of the vision system and the hole axis. The position of the hole is the intersection between the hole axis and the surface region around the hole opening.

### BACKGROUND OF THE INVENTION

In the most general terms, this invention relates to an approach to detect the hole orientation and its position on a part with a vision system mounted on the industrial robot.

In some industrial applications holes on a part need to be inspected after drilling process to control quality. This can be done with an industrial robot equipped with a vision system.

### SUMMARY OF THE INVENTION

The vision system consists of a laser scanner and a camera. The laser scanner is used to scan a surface around the hole opening. The camera is used to detect the image position of the hole opening.

In the first step the orientation of the hole axis is determined by using alignment algorithm. Then the hole position is determined by intersecting the hole axis with the surface around the hole opening.

### BRIEF DESCRIPTION OF THE DRAWINGS

FIG. 1 is a schematic overview of the preferred vision system for implementing the present invention.

FIG. 2 is schematic representations of the images in the field of view of the camera.

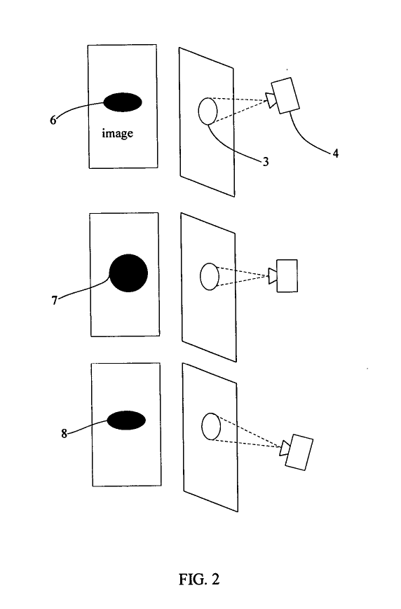

FIG. 3 is a schematic showing the process of determining the surface around the hole opening.

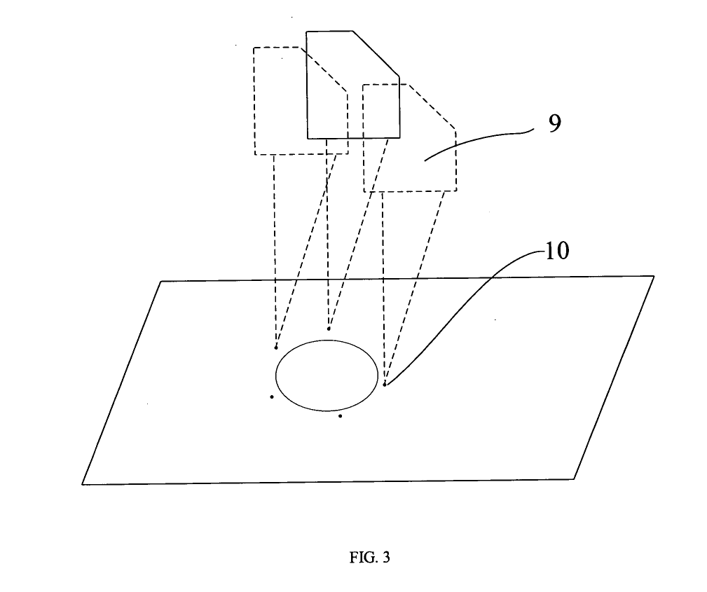

### REFERENCE NUMERALS IN DRAWINGS

1 base
2 part or workpiece
3 hole
4 optical sensor or a camera
5 robot
6, 7, and 8 images in the field of view of the camera.
9 laser scanner
10 points around the hole opening

### DESCRIPTION OF THE PREFERRED EMBODIMENT

I. Determine the Hole Orientation in a Camera Coordinate System

The parameter to be determined is a straight line equation representing the hole axis: (nx, ny, nz, X, Y, Z) where (nx, ny, nz) represents the orientation and (X,Y,Z) represents any point on the line.

Step 1: Alignment of the Vision System with the Hole Axis

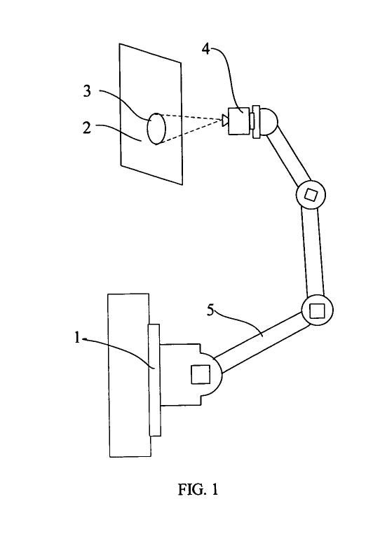

As shown in FIG. 1 orient the robot 5 to get into the pose to have the hole axis roughly align with the camera. The robot program is based on the rough orientation and position of the hole 3 that is pre-defined with the original design of the part with holes from the CAD model of the part or from other resource. Rotate the camera orientation 4 vertically and horizontally and take a snap shot of the hole opening image 6, 7, and 8 during the robotic searching process. In order to obtain a high contrast image an illumination system is used which can be mounted on the robot arm. For each image the pattern of the hole-opening cross-section looks like a circular shape 6, 7, and 8 (such as a disc or circular, sporty or dot, or elliptical shape). The opening portion has low optical intensity (dark) and the outside has high optical intensity (relatively white) due to the high illumination. Calculate the image area of the hole-opening cross-section and find its feature like roundness for cylinder type holes with an image processing algorithm. The alignment position is determined based on the fact that the image area of hole opening cross section is maximized. This criterion is independent of the real shape of the hole opening cross-section. Some other criteria like roundness and pattern match may apply depending on the real shape of the hole opening cross section.

Step 2: Determination of the Hole Orientation in the Camera Coordinate System

Detect the center position of the hole opening image (x,y). The hole orientation in the camera system will be determined by the following line equations (image project relation)

$$\begin{matrix}x = fx \frac{m 11 * X + m 21 * Y + m 31 * Z + tx}{m 13 * X + m 23 * Y + m 33 * Z + tz} & ( 1 a ) \\ y = fy \frac{m 12 * X + m 22 * Y + m 32 * Z + tx}{m 13 * X + m 23 * Y + m 33 * Z + tz} & ( 1 b )\end{matrix}$$

where (fx, fy) are the camera focal length in x and y directions; (tx,ty,tz) are translations, and (m11, m12, m13, m21, m22, m23, m31, m32, m33) are rotation matrix of the camera with respective to a reference coordinates. Those parameters are calibrated previously. Equation (1) actually represents a ray that connects the image center and the lens center.
Step 3: . Convert the Hole Orientation in a Part Coordinate System

It is more convenient to the hole orientation and position in a fixed coordinate system like the part itself.

Assume they are ( nx′, ny′, nz′, X′, Y′, Z′)

The transformation can be done with the following robot kinematics equation

Define
T_{w}^{v}=(T_{b}^{w})⁻¹*T₀*Tₜ^{v} (2)
Where T_{b}^{w} is the transformation from the part coordinates system to the robot base; Tₜ^{v} is the transformation from vision system to robot tool mounting flange (tool0); and coordinate system T0 is the position matrix of the robot mounting flange coordinate system in the robot base. They are all calibrated parameters.
Then
(X′,Y′,Z′,1)′=T_{w}^{v}*(X,Y,Z,1)′; (3)
(nx′,ny′,nz′)′=R_{w}^{v}*(nx,ny,nz)′; (4)
where R_{w}^{v} is the rotation matrix of the transformation matrix T_{w}^{v}
II. Determination of the Hole Position
Step 1: Determination of the Surface (Plane) Around the Hole Opening

Use the laser scanner 9 to scan the surface of the part 2 that is around the hole opening. If a laser scanner is a laser pointer or laser displacement sensor that measures the single point 10, at least 5 points around the hole opening have to be measured. Do surface fitting to determine the surface equation. For simplicity we assume that the surface can be modeled as a plane as approximation. It can be described by the following plane equation
nx*X+ny*Y+nz*Z=d (5)
where (nx, ny, nz) is the normal of the plane and d is the plane offset that are determined by the least square plane fitting algorithm. If the reading of the laser scanner is based on the robot base coordinate system it has to be converted into a fixed reference coordinate system.
The plane equation can be converted into a fixed part coordinate system by using the following relation:
(X′,Y′,Z′,1)_{w}′=(T_{b}^{w})⁻¹*(X,Y,Z,1)_{b}′; (6)
where T_{b}^{w} is the transformation from the part coordinates system to the robot base;
Step 2. Calculation of the Hole Opening Position

The intersection of the hole axis orientation described by equations (1) to (4) and the surface plane described by equations (5) and (6) around the hole opening gives the hole opening position. That is the solution of eqs.(1) to (6) for (X′,Y′,Z′).

What is claimed:

1. A method of determining the position and orientation of a hole on a plane or curved surface of an object in space with said hole having at least two identifiable features which includes:
(a) holding the optical sensor or vision system in a first position;
(b) recording a first image of the object hole by the vision system;
(c) relocating the vision system by a predetermined pose;
(d) recording a second image of the object hole by the vision system, the object hole remaining fixed with reference to the relocation of the vision system from its first to its second pose;
(e) in the camera's coordinate system, determining the alignment of the hole axis based on each of the elliptical images using the image processing algorithm for holes of a circular shape or other known shape, based on the optical intensity change of the hole and the surface around the hole;
(f) converting the hole axis or hole alignment from the camera coordinate system to the part coordinate system,
(g) using a second sensor to measure the surface plane that contains the hole opening, by either scanning the surface area around the hole or measuring at least three spots to determine the surface;
(h) obtaining the plane equation;
(i) finding the intersecting point of the orientation axis and the surface plane equations as the position of the hole in the corresponding coordinate.

2. The method of claim 1 which includes:
determining the location of said feature with respect to the robot coordinate system after calculating the two types of measuring results.

3. The method of claim 1 which includes:
moving the sensor from an acquisition site to a target site while steps (a)-(i) are executed, or moving the object from an acquisition site to a target site while steps (a)-(i) are executed,

4. The method of claim 1 which includes:
recording the images using binary processing after recording said first and second images.

5. The method of claim 1 which includes:
establishing an inverse camera transform for a first camera;
reading the inverse camera transform from a memory; and
calculating the center of the vision system in reference to its recording the first image subsequent to calculating the alignment axis and surface plane

6. The method of claim 5 which includes:
calculating the forward transform of a second camera by manipulation of the appropriate transformation multiplier;
calculating subsequently the center of the vision system in reference to its recording the second image; and determining the elliptical alignment of each image.

7. The method of claim 6 which includes:
determining the alignment from the maximized optical density from a first image plane;
determining the alignment from the maximized optical density from a second image plane;

8. The method of claim 1 wherein the calculation of the hole orientation and position are effected by coordinate systems used.

9. A robot, having a robot coordinate system, for determining the orientationa dn position of a hole on the surface of a part in space, said hole having at least two identifiable features which comprises:
means to hold the vision sensor in a first position;
means to record a first image of the object hole by a vision system;
means to rotate the vision sensor by a predetermined pose;
means to record a second image of the object hole by the vision system, the part with object holes being fixed with reference to the rotation of the vision sensor from its first to its second position;
means to determine the alignment of each image;
means to measure the surface plane using a displacement sensor;
means to determine the distance of the plane in either the camera coordinate system or the part coordinate system;
means to calculate the intersection of the plane and the hole axis;
means to express the orientation and location and transform it into other coordinate systems.

10. The system of claim 9 which comprises:
means to determine the orientation and location of the hole with reference to the robot coordinate system.

11. The system of claim 9 which comprises:
means to move the sensor from an acquisition site to a target site while the sensor is held and rotated.

12. The system of claim 9 wherein each of the vision systems comprises:
a housing;
a lens secured to the housing;
a sensor secured to the housing in optical communication with the lens, the element adapted to produce a binary image.
References:
U.S. Pat. No. 6,301,763, Determining position or orientation of object in three dimensions
U.S. Pat. No. 6,314,631, Vision target based assembly
